(19) United States
(12) Patent Application Publication
(10) Pub. No.: US 2017/0076413 A1
(43) Pub. Date: Mar. 16, 2017

(54) GRADEBOOK CLEARINGHOUSE

(71) Applicant: eBackpack, Inc., Rockwall, TX (US)

(72) Inventors: Michael Zilinskas, Heath, TX (US); Jonathan Achenbach, Rowlett, TX (US); Douglas Mayer, Orland Park, IL (US)

(21) Appl. No.: 15/195,605

(22) Filed: Jun. 28, 2016

Related U.S. Application Data
(60) Provisional application No. 62/219,642, filed on Sep. 16, 2015.

(51) Int. Cl. G06Q 50/20; G06Q 10/10; H04L 29/08

(52) U.S. Cl. CPC G06Q 50/205; H04L 67/26; H04L 67/06; G06Q 10/10

(57) ABSTRACT

The present invention relates generally to the fields of education gradebook management for a plurality of users using a plurality of gradebook systems.

### CROSS-REFERENCE

This application claims the benefit of U.S. Provisional Application No. 62/219,642 filed Sep. 16, 2015, which application is incorporated herein by reference.

### STATEMENT REGARDING FEDERALLY FUNDED RESEARCH

None.

### BACKGROUND

I. Field of the Invention

The present invention relates generally to the fields of education gradebook management for a plurality of users using a plurality of gradebook systems.

II. Description of Related Art

There are a plethora of tools that allow student submissions to be graded electronically with new programs and related businesses appearing regularly. These grades must be reentered into one or more of the plethora of available gradebooks that the student's school or teacher has chosen to use. Additionally, there are a plethora of tools that may be used to display these Grades in a number of different ways for state reporting, parent review, internal school review, etc.

Numerous of these tools have methods to programmatically create, enter, modify, delete and/or retrieve grades. However, it is cumbersome and preventative for any single tool provider to create and maintain a programmatic interface to multiple other tools due to the wide variance of implementations and their constant changes.

These tools must all communicate and programmatically transfer grades between the tools in an organized manner to maximize the value of each tool. However, each tool typically has a unique interface making the transfer and completion of data in each system cumbersome, often prohibitively so. Grades may be moved using one of many interface techniques including manual entry, manual transferred through file import/export, direct database query, and application programming interfaces. This variety of interfaces and resulting increase in unnecessary manual transfer often leads to incomplete or inaccurate reports.

### SUMMARY

In one embodiment, the present disclosure provides a computing apparatus having at least one microprocessor and memory storing instructions configured to instruct the at least one microprocessor to perform operations, the computing apparatus comprising a system configured to receive input from a plurality of users using a plurality of different interface formats; wherein transferred data includes grades; wherein a data transfer may be initiated through a provided interface without knowledge of the required format of other users; wherein said system is configured to convert said information provided in one format into the format required by a user; and wherein said system is configured to allow for a plurality users to push and/or pull data from said system.

In one embodiment the present disclosure provides a method of managing grade or assignment information transfer between a plurality of users comprising receiving said information from said users; converting format of said information into format required by other users; providing said information to said other users.

It is contemplated that any embodiment of a method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternative are mutually exclusive, although the disclosure supports a definition that refers to only alternatives and “and/or.”

Throughout this application, the term “about” is used to indicate that a value includes the standard deviation of error for the device or method being employed to determine the value.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The use of the term “user” may refer to a human or interfacing tool or program.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 provides a summary showing how system acts as a clearinghouse between a plurality of Grade Owners, Grade Providers, Grade Users, and Gradebooks.

FIG. 2 depicts an exemplary process for a grade provider to create an assignment in a gradebook through the system.

FIG. 3 depicts an exemplary process for a grade provider to update or delete an assignment in a gradebook through the system.

FIG. 4 depicts an exemplary process for a grade provider to enter a grade in a gradebook through the system.

FIG. 5 depicts an exemplary process for a grade provider to update or delete a grade in a gradebook through the system.

FIG. 6 depicts an exemplary process for a grade user to retrieve a grade from a gradebook through the system.

FIG. 7 depicts an exemplary process for clearinghouse to manage grades for grade deletion.

FIG. 8 depicts an exemplary process for the grade owner to initiate transfer of assignment and grade information to gradebook.

FIG. 9 depicts an exemplary process for the grade owner to initiate pushing Assignment and Grade Information to a Grade User.

FIG. 10 depicts an exemplary process for the system or Clearinghouse distributing grades through a publish-subscribe methodology.

### DESCRIPTION

While there are current methods of managing grades and gradebooks, as noted above, they are generally cumbersome, limited to a particular system and interface and require considerable manual manipulation of data or custom programming to transfer the data. Accordingly, there exists a need for improved system of grade distribution. The present disclosure resolves these challenges by providing a common interface to initiate grade transfer, distribution, and collection amongst a plurality of gradebooks, grade users, and grade providers. The system, sometimes referred to herein as a Clearinghouse, provides this communication through a common interface meaning that the action initiator does not require knowledge of the custom interfaces employed by the individual grade users, grade providers, and gradebooks being integrated with. Such information transfer, distribution, or collection may be initiated by the grade owner, gradebook, grade user, or grade provider. Such information transfer, distribution, or collection may be completed in a publish-subscribe methodology or a directed methodology. Such information transfer, distribution, or collection may be collected in synchronous or asynchronous manner. A single tool may provide the function of one or more of a Grade Provider, Grade User, and Gradebook.

By “Grades” is meant discussions of Grades encompassing grades or assignments including all attributes and descriptive information thereof.

By “Gradebook” is meant a grade repository.

By “Grade Provider” is meant any program or source that would provide or generate a Grade. These may include a testing program, learning management system, or similar.

By “Grade User” is meant any program that uses, displays or reports Grades including a learning management system, parent portal, reporting agency, or similar.

By “Grade Owner” is meant school or other agency, or individual that is responsible for the reviews or scores handled by the systems.

By “Standards” is meant any framework or set of standards used for reporting, such as Common Core, Common Core State Standards, Texas Essential Knowledge and Skills, Virginia's Standards of Learning, International Technology and Engineering Educators Association Technology Literacy Standards, National Standards, and various others.

The present disclosure provides systems and methods for managing the data transfer between a plurality of Gradebooks, Grade Users, and Grade Providers. That is the system and methods described herein provide for conversion of multiple different Gradebook, Grade User and Grade provider interface formats to be presented as a single format that is stored and managed on a central system, referred to herein as a Gradebook Clearinghouse. The Gradebook Clearinghouse provides common interfaces such that an action initiator does not need to tailor its request format for a specific Gradebook, Grade User, or Grade Provider.

The system provides a common interface to manage grade and assignment information transfer between gradebooks, grade providers, and grade users where grade owner may control and specify permissions and access to information.

The system allows for the creation, modification, and deletion of assignments in the gradebook up to the provided capability of the specific gradebook. This may include supplemental items up to and including all information known such as instructions, feedback, or even materials including files and website links. The system programmatically creates, deletes, and manipulates assignments, submissions, and grades in the Grade Owner's Gradebook in a standard manner. This action may be initiated by (a) the Grade Provider using a common interface to push the requisite information to the system which then pushes it to the Gradebook, (b) the Grade Owner using a common interface to instruct the system to pull the requisite information from the Grade Provider and push it to the Gradebook, or (c) the Gradebook using a common interface to pull the requested information from the system which, in turn, pulls the requested information from the Grade Provider through the system.

The system programmatically provides assignments, submissions, and grades information to Grade Users in a standard manner. This action may be initiated by (a) the Grade User using a common interface to pull the requisite information from the system which, in turn, may pull it from the Gradebook, (b) the Grade Owner using a common interface to instruct the system to push the requisite information to the Grade User which the system may have pulled from the Gradebook, (c) the Gradebook using a common interface to push information to the Grade User through the system, (d) the Grade User using a common interface to pull the requisite information from the system which, in turn, may pull it from the Grade Provider, (e) the Grade Owner using a common interface to instruct the system to push the requisite information to the Grade User which the system may have pulled from the Grade Provider, (f) the Grade Provider using a common interface to push information to the Grade User through the system.

The initiating action is completed through a common interface that is not Grade Provider, Grade User, or Gradebook specific although multiple interfaces (including specific and non-common interfaces) can be adopted by the system. The transfer may be initiated by the Grade Provider, Grade User, Gradebook, Grade Owner, or System. The system then fetches any additional required data, using tool specific interfaces, manipulates the information to match the required format for the target tool specific interface, and transmits the data to the target tool. The system provides the requisite error handling and returns the required response to the action initiator. This may be done synchronously or asynchronously and the system later may handle retries and status.

The common interface between the system and grade owners, grade providers, and grade users may take on different embodiments. Multiple common interfaces may be provided to complete a single task.

Embodiments of the common interface between the system and the action initiator may include, but not be limited to, application program interface, graphical user interface, scheduled task, and file transfer.

A separate interface may be implemented and maintained for each supported gradebook, grade user, and grade provider. The tool specific interfaces implemented by the system to interact with a specific Gradebook, Grade Provider, or Grade User may include but are not limited to application program interface, file transfer, screen scrape, manual entry, direct database query, automated form filling, or any other format specified by the target gradebook.

The system may allow the assignment, modification, and deletion of grades in the gradebook up to the provided capability of the specific gradebook. Provided statuses, errors, and identifiers will vary by target gradebook. These actions may be handled individually or as a batch process.

The system may generate, provide, and maintain its own set of unique identifiers for items in the clearing house; e.g. schools, institutions, classes or groups, grades, students, and/or teachers.

In one embodiment, the system may accept reference standards, or other information, for all assignments and store them internally regardless of whether the target gradebook accepts the provided information type. Such storage may be indefinite or for a specified length of time. In this embodiment, the system could then provide the stored information to grade users. The system may store all provided information or only the information not stored by the gradebook. In an embodiment where the system stores all information, grades may be reset or sent in one or all of the grade users and gradebooks to a specific point in time based on the information stored in the system.

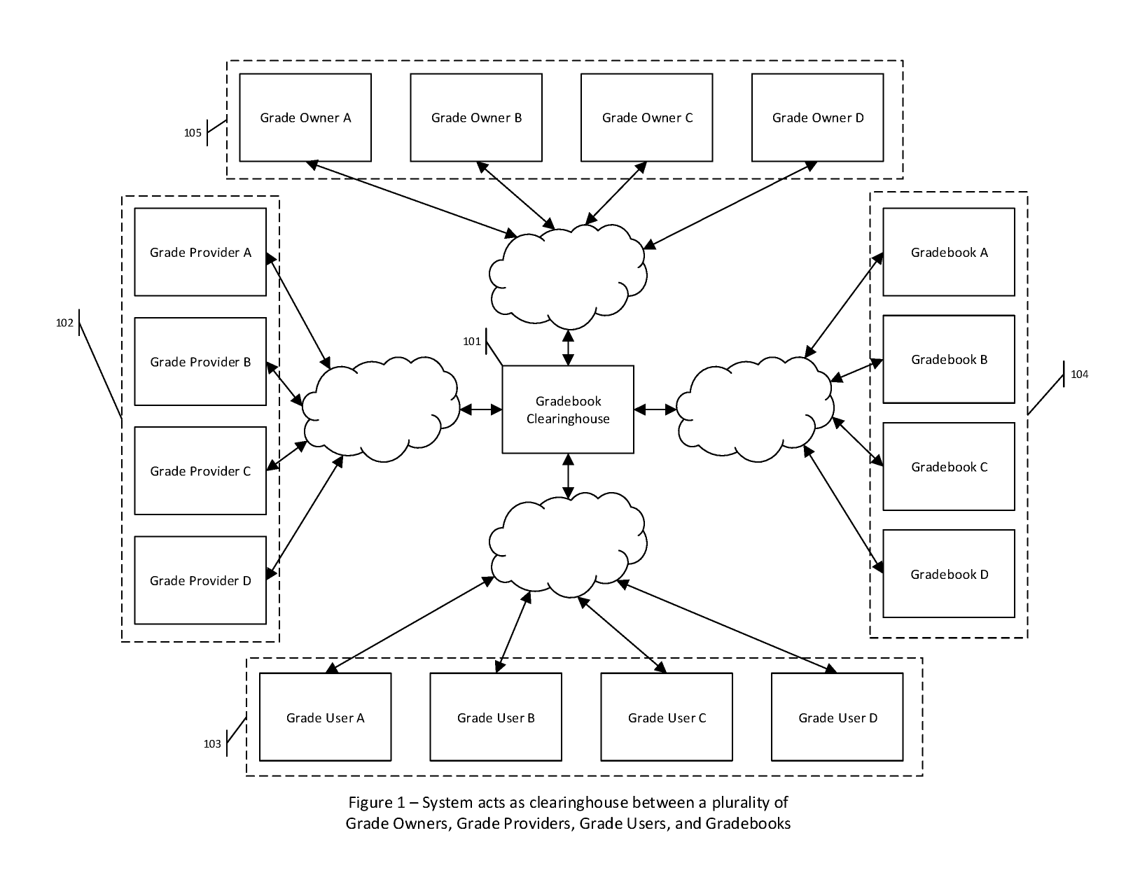

Turning to FIG. 1, the system (101) provides bidirectional communication with a plurality of Grade Providers (102) such as quiz platforms, homework platforms, and learning managements systems. Communication initiated by the Grade Provider is completed through a common interface such that the Grade Provider does not need to know the target Gradebook or Grade User type. Communication initiated by the system may be completed through a tool specific interface. This interface could be implemented through, but is not limited to, internet, intranet, or any other communication mechanism. Individual information transfers could be directed by the action initiator or could be completed in a publish-subscribe methodology. In a publish-subscribe methodology, the grade owner specifies permissions, gradebooks and grade users subscribe to information, gradebooks and grade providers publish information, and the system distributes published information to subscribers per the assigned permissions or subscriptions.

System (101) provides bidirectional communication with a plurality of Grade Users (103) such as learning management systems, parent portal, and reporting agencies. Communication initiated by the Grade User is completed through a common interface such that the Grade Provider does not need to know the target Gradebook or Grade Provider type. Communication initiated by the system may be completed through a tool specific interface.

System (101) provides bidirectional communication with a plurality of Gradebooks (104). Communication initiated by the Gradebook is completed through a common interface such that the Grade Provider does not need to know the target Grade User or Grade Provider type. Communication initiated by the system may be completed through a tool specific interface.

System (101) provides bidirectional communication with Grade Owners (105). Communication initiated by the Gradebook is completed through a common interface such that the Grade Owner is able to manage data in multiple tools through a single interface.

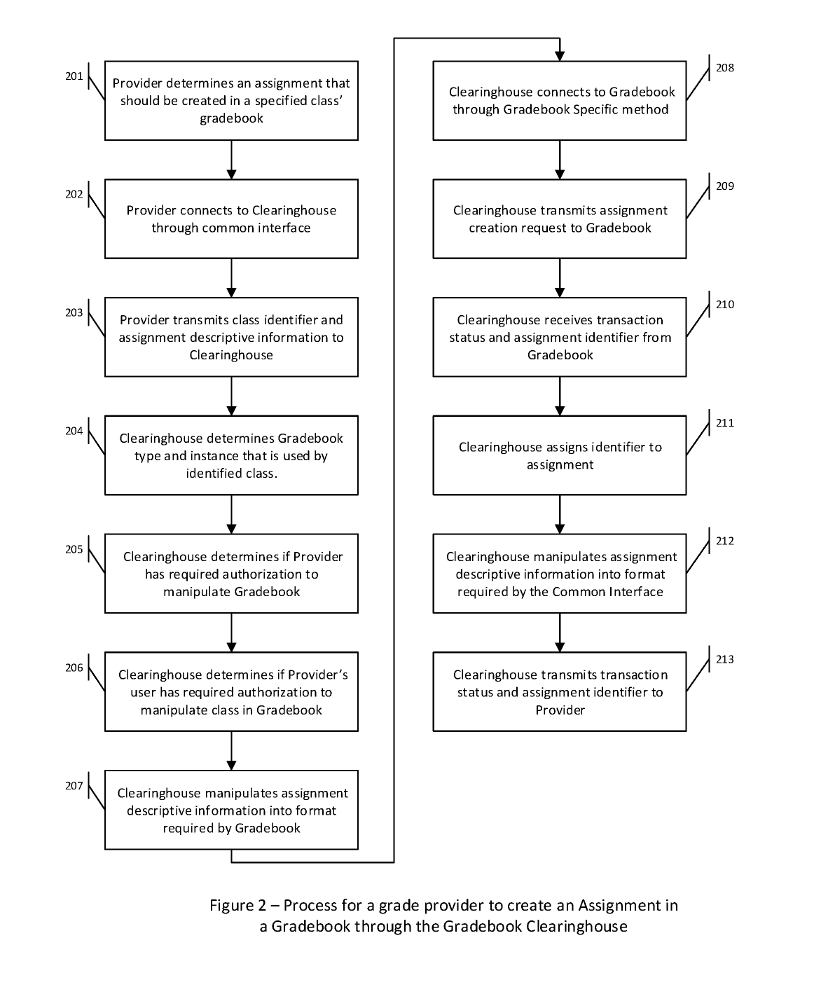

Turning to FIG. 2, one of the plurality of grade providers (102) determines an assignment that should be created in a specified class' gradebook (step 201). The Provider then connects to the system (101) through a common interface (step 202), meaning that it does not need to know the type of gradebook it is connecting to, nor the type of interface the target gradebook requires. The provider then transmits a class identifier and assignment descriptive information to the system (101) (step 203). The class identifier may be a combination of identifier's (such as school code, course code, and section id), or an individual (such as a unique identifier provided by the system). The assignment of descriptive information may include assignment name, assignment type, available points, extra credit points, standards reference, administrator or teacher credentials, and visibility controls among others.

The system (101) then determines which gradebook is utilized by the target class or group using the provided class identifier and its knowledge of the relationships (step 204). The system (101) then determines if the provider has sufficient permissions to add assignments to the indicated gradebook according to the permissions established by the grade owner and/or the permissions of the target gradebook (step 205). The system (101) then determines if the provider's user has sufficient permissions to add assignments to the indicated class or group according to the permissions established by the grade owner through the system (101) or through the target gradebook (step 206).

The system (101) then arranges the provided data into the format required by the target gradebook (step 207). The format may conform to that necessary for API transfer, form filling, file transfer, manual entry, or any other transfer type required by the target gradebook. The system (101) then connects to the target gradebook through the target specific method (step 208) and transfers the assignment creation request to the target gradebook (step 209).

The system (101) then receives assignment identifiers, status, and errors from the gradebook through the gradebook specific interface (step 210). The system (101) then generates a Universally Unique Identifier (UUID) for the assignment (step 211). The system (101) then manipulates the gradebook response and system UUID into the format necessary for the Common Interface (step 212) and transmits said information to the grade provider (step 213). Step 213 may be completed synchronously, or asynchronously in response to a separate status query by the grade provider to the system (101). Additionally, the status query does not have to be initiated but may be logged, sent to a remote API or web hook, or otherwise maintained for future use.

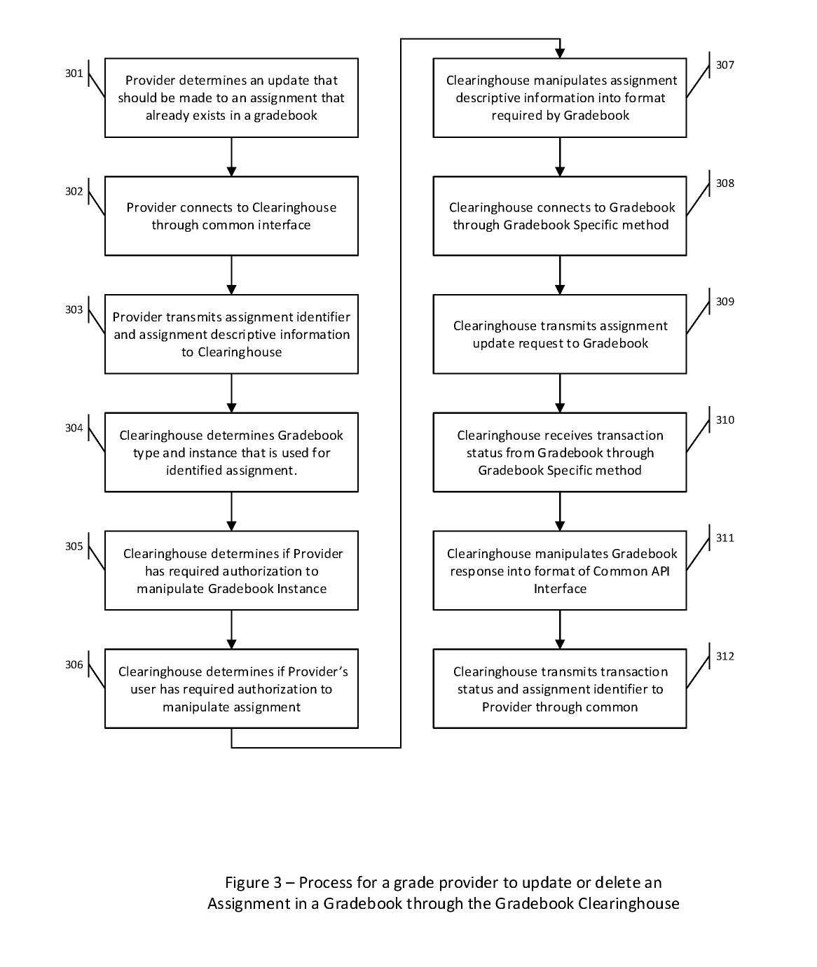

Turning to FIG. 3, one of the plurality of grade providers (102) determines an assignment that should be modified (step 201). The Provider then connects to the system (101) through a common interface (step 302), meaning that it does not need to know the type of gradebook it is connecting to, nor the type of interface the target gradebook requires. The provider then transmits an assignment identifier to the system (101) (step 303). The class identifier may be a combination of identifier's (such as school code, course code, and section id), or an individual identifier (such as a system UUID). The assignment descriptive information may include assignment name, assignment type, available points, extra credit points, standards reference, administrator or teacher credentials, and visibility controls among others. The provider may provide all assignment information, or only the assignment information that should be changed.

The system (101) then determines which gradebook is housing data for the specified assignment using the provided class identifier and its knowledge of the relationships (step 304). The system (101) then determines if the provider has sufficient permissions to modify assignments in the indicated gradebook according to the permissions established by the grade owner directly or through the gradebook (step 305). The system (101) then determines if the provider's user has sufficient permissions to modify the indicated assignments according to the permissions established by the grade owner through the system (101) or through the target gradebook (step 306).

The system (101) then arranges the provided data into the format required by the target gradebook (step 307). The format may conform to that necessary for API transfer, form filling, file transfer, manual entry, or any other transfer type required by the target gradebook. The system (101) then connects to the target gradebook through the target gradebook specific method (step 308) and transfers the assignment modification request to the target gradebook (step 309).

The system (101) then receives transaction status and errors from the gradebook through the gradebook specific interface (step 310). The system (101) then manipulates the gradebook response into the format necessary for the Common Interface (step 311) and transmits said information to the grade provider (step 312). Step 312 may be completed synchronously, or asynchronously in response to a separate status query by the grade provider to the system (101). Additionally, the status query does not have to be initiated but may be logged, sent to a remote API or web hook, or otherwise maintained for future use.

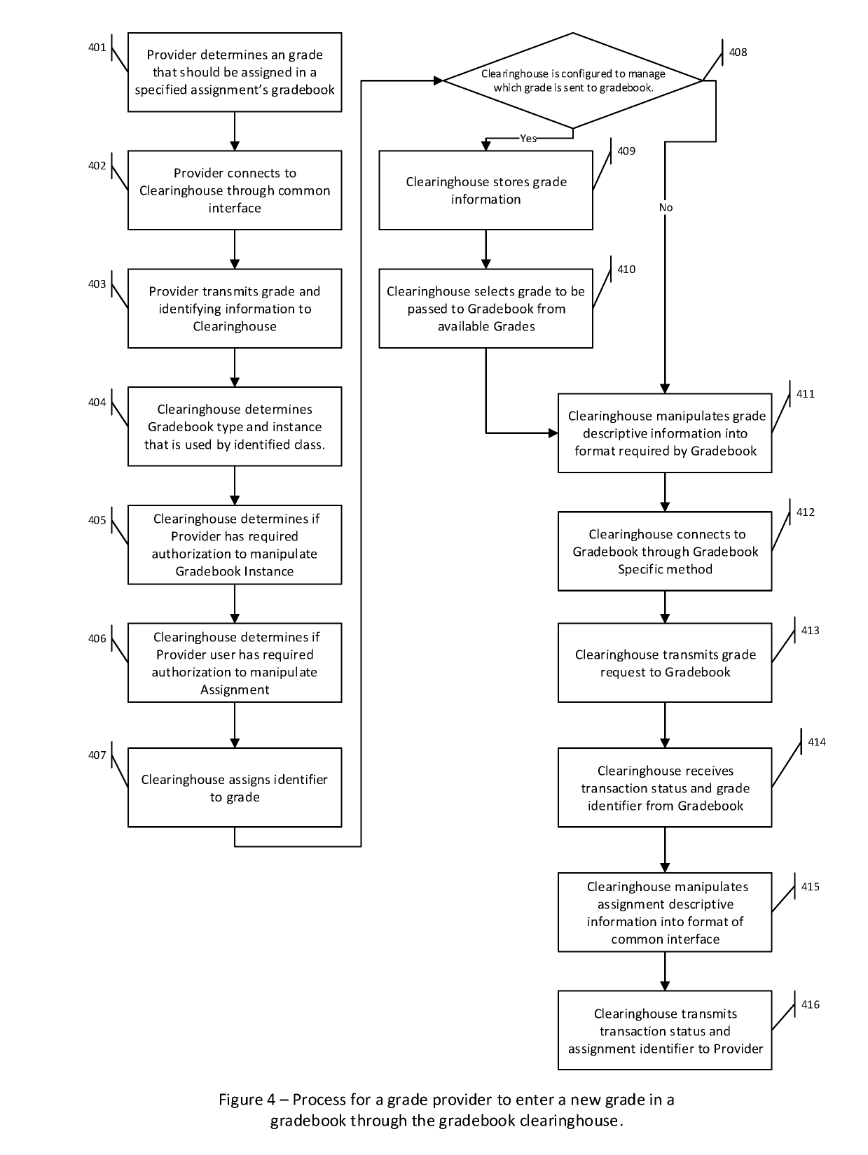

Turning to FIG. 4, one of the plurality of grade providers (102) determines a grade that should be assigned in a specified assignments' gradebook (step 401). The Provider then connects to the system (101) through a common interface (step 402), meaning that it does not need to know the type of gradebook it is connecting to, nor the type of interface the target gradebook requires. The provider then transmits a grade and sufficient identifier to the system (101) (step 303). The identifier may be a combination of identifiers such as assignment, school, class, and student identifiers. The grade may be freeform, points based, percentage based, alpha scale based, or any other supported scales based.

The system (101) then determines which gradebook is utilized for the identified grade using the provided identifier and its knowledge of the relationships (step 404). The system (101) then determines if the provider has sufficient permissions to manipulate grades in the indicated gradebook according to the permissions established by the grade owner and/or the permissions of the target gradebook (step 405). The system (101) then determines if the provider's user has sufficient permissions to manipulate grades in the target assignment according to the permissions established by the grade owner through the system (101) or through the target gradebook (step 406). The system (101) then generates a Universally Unique Identifier (UUID) for the grade (step 407).

The system may be configured to compare all available grades that match the provided identifiers and determine the correct grade to be entered the grade book (step 408). The selection criteria may be controlled by the Grade Owner. The selection criteria may be based on grade date and time, grader, grading tool, etc. The selection criteria may vary based upon the target gradebook or grade user. If the system (101) is configured to manage grade selection, then it will store the grade locally in the system (step 409). This storage may be for an extended period of time or just long enough to complete the grade comparison and any necessary grade distribution. The system (101) then compares available grades and selects the grade to pass to the gradebook based upon the defined criteria (step 410). Compared grades may be stored within the system (101) or pulled from one or more of the plurality of grade providers (102) or gradebooks (104).

The system (101) then arranges the provided data into the format required by the target gradebook (step 411). The format may conform to that necessary for API transfer, form filling, file transfer, manual entry, or any other transfer type required by the target gradebook. The system (101) then connects to the target gradebook through the target specific method (step 412) and transfers the grade information to the target gradebook (step 413).

The system (101) then receives relevant identifiers, status, and errors from the gradebook through the gradebook specific interface (step 414). The system (101) then manipulates the gradebook response and system UUID into the format necessary for the Common Interface (step 415) and transmits said information to the grade provider (step 416). Step 416 may be completed synchronously, or asynchronously in response to a separate status query by the grade provider to the system (101). Additionally, the status query does not have to be initiated but may be logged, sent to a remote API or web hook, or otherwise maintained for future use.

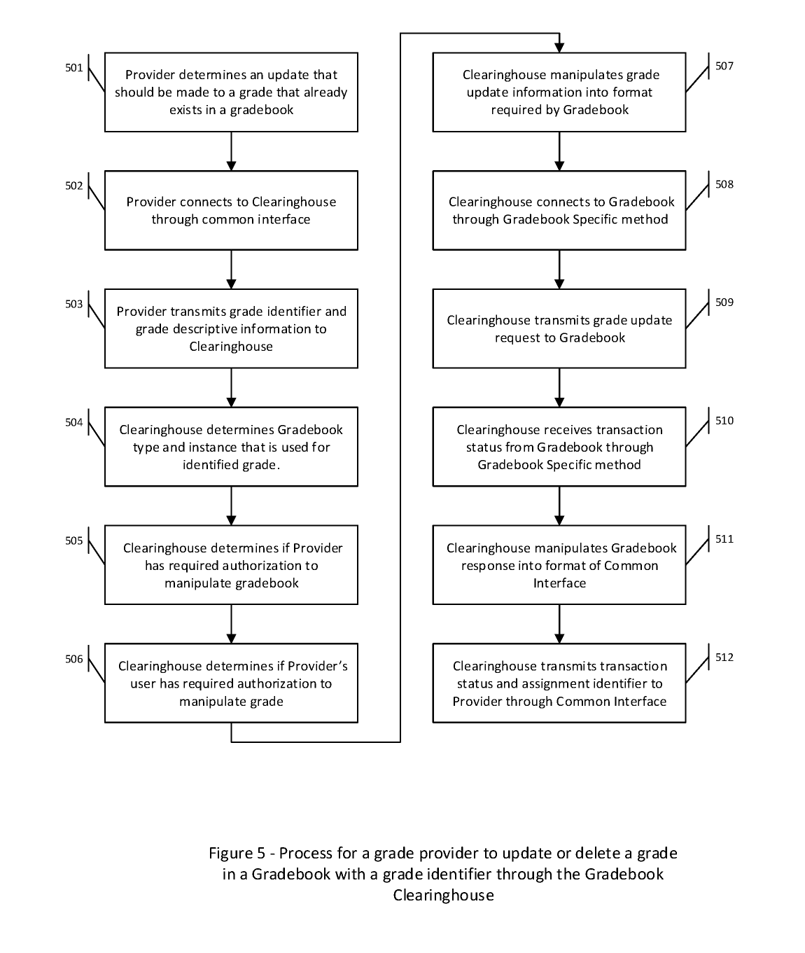

Turning to FIG. 5, one of the plurality of grade providers (102) determines a grade that should be modified (step 501). The update may be modification or deletion. The Provider then connects to the system (101) through a common interface (step 502), meaning that it does not need to know the type of gradebook it is connecting to, nor the type of interface the target gradebook requires. The provider then transmits the modification and grade identifier to the system (101) (step 503). The identifier may be a combination of identifiers (such as assignment identifier and student identifier) or a single identifier (such as system UUID). The grade may be freeform, points based, percentage based, alpha scale based, or any other supported scales based.

The system (101) then determines which gradebook is utilized for the identified grade using the provided identifier and its knowledge of the relationships (step 504). The system (101) then determines if the provider has sufficient permissions to manipulate grades in the indicated gradebook according to the permissions established by the grade owner and/or the permissions of the target gradebook (step 505). The system (101) then determines if the provider's user has sufficient permissions to manipulate the target grade according to the permissions established by the grade owner through the system (101) or through the target gradebook (step 506).

The system (101) then arranges the provided data into the format required by the target gradebook (step 507). The format may conform to that necessary for API transfer, form filling, file transfer, manual entry, or any other transfer type required by the target gradebook. In the event of the provider specifying grade deletion, the system (101) may specify a grade modification to 0 points, or similar, if the target gradebook does not provide for grade deletion. Acceptability of such action substitutions may be specified by the grade provider or grade owner. The system (101) then connects to the target gradebook through the target specific method (step 508) and transfers the assignment modification request to the target gradebook (step 509).

The system (101) then receives relevant identifiers, status, and errors from the gradebook through the gradebook specific interface (step 510). The system (101) then manipulates the gradebook response into the format necessary for the Common Interface (step 511) and transmits said information to the grade provider (step 512). Step 512 may be completed synchronously, or asynchronously in response to a separate status query by the grade provider to the system (101). Additionally, the status query does not have to be initiated but may be logged, sent to a remote API or web hook, or otherwise maintained for future use.

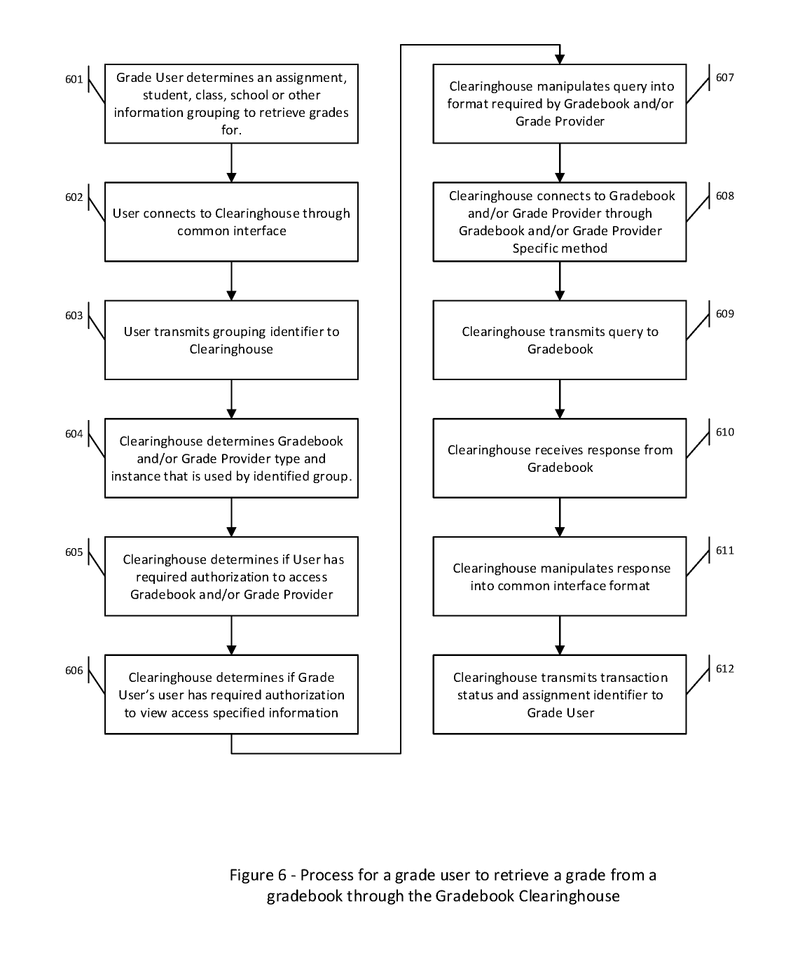

Turning to FIG. 6, one of the plurality of grade users (103) determines an assignment, student, class, school, or other information grouping to retrieve grades for (step 601). The Provider then connects to the system (101) through a common interface (step 602), meaning that it does not need to know the type(s) of gradebook(s) and/or grade provider(s) it is connecting to, nor the type of interface(s) the target gradebook(s) and/or grade provider(s) require. The user then transmits grouping identifier to the system (101) (step 603). The identifier may be a combination of identifiers (such as assignment identifier and student identifier) or a single identifier.

The system (101) then determines which gradebook(s) is utilized for the identified information using the provided identifier and its knowledge of the relationships (step 604). The system (101) then determines if the user has sufficient permissions to access the required gradebook(s) and/or grade provider(s) according to the permissions established by the grade owner directly or through the gradebook(s) and/or grade provider(s) (step 605). The system (101) then determines if the Grade User's user has sufficient permissions to access the requested information according to the permissions established by the grade owner through the system (101) or through the target gradebook(s) and/or grade providers (step 606).

The system (101) then manipulates the query into the format format(s) required by the target gradebook(s) and/or grade provider(s) (step 607). The format may conform to that necessary for API transfer, screen scraping, file transfer, or any other transfer type required by the target gradebook(s) and/or grade provider(s). The system (101) then connects to the target gradebook through the target specific method (step 608) and transmits the query to the target gradebook(s) and/or grade provider(s) (step 609).

The system (101) then receives response from gradebook(s) and/or grade provider(s) through the source specific interface (step 610). The system (101) then manipulates the provided information response into the format necessary for the Common Interface (step 611) and transmits said information to the grade user (step 612).

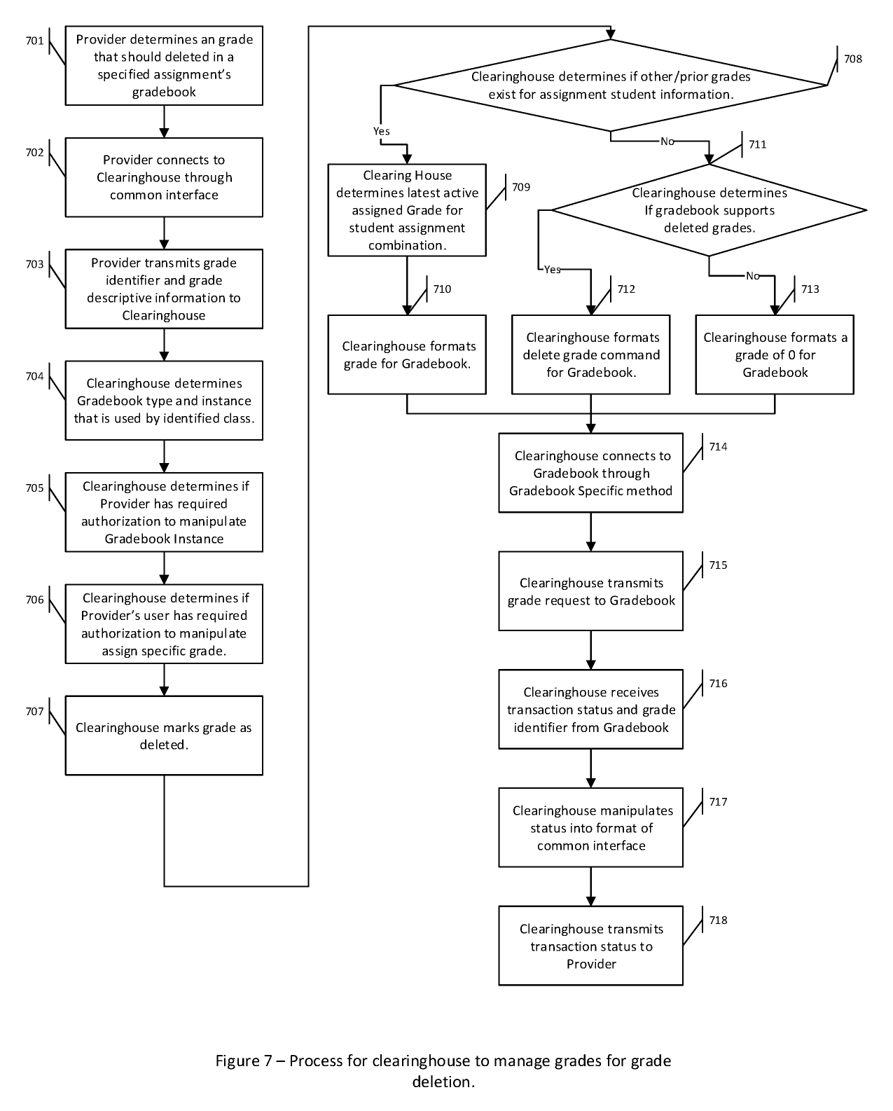

Turning to FIG. 7, one of the plurality of grade providers (102) determines a grade that should be deleted (step 701). The Provider then connects to the system (101) through a common interface (step 702), meaning that it does not need to know the type of gradebook it is connecting to, nor the type of interface the target gradebook requires. The provider then transmits the modification and grade identifier to the system (101) (step 703). The identifier may be a combination of identifiers (such as assignment identifier and student identifier) or a single identifier (such as system UUID). The grade may be freeform, points based, percentage based, alpha scale based, or any other supported scales based.

The system (101) then determines which gradebook is utilized for the identified grade using the provided identifier and its knowledge of the relationships (step 704). The system (101) then determines if the provider has sufficient permissions to manipulate grades in the indicated gradebook according to the permissions established by the grade owner and/or the permissions of the target gradebook (step 705). The system (101) then determines if the provider's user has sufficient permissions to manipulate the target grade according to the permissions established by the grade owner through the system (101) or through the target gradebook (step 706). If the system assigns UUID's to grades or stores grades locally, the system will mark the identified grade as deleted (step 707).

The system (101) then determines if other/prior grades exist for the identified student assignment combination that should replace the deleted grade (step 708). Compared grades may be stored within the system (101) or pulled from one or more of the plurality of grade providers (102) or gradebooks (104). If other grades are available, the system (101) then compares available grades and selects the grade to pass to the gradebook based upon the defined criteria (step 709). The selection criteria may be based on grade date and time, grader, grading tool, etc. The selection criteria may vary based upon the target gradebook or grade user. The system (101) then arranges the selected grade information into the format required by the target gradebook (step 710). The format may conform to that necessary for API transfer, form filling, file transfer, manual entry, or any other transfer type required by the target gradebook.

If the system (101) determines that the selected grade should be deleted from the gradebook and not replaced, the system (101) determines if the target gradebook supports grade deletion (step 711). If the gradebook supports grade deletion, then the system (101) formats the grade deletion request as required by the gradebook specific interface (step 712). If the gradebook does not support grade deletion, then the system (101) formats a grade update request as required by the grade specific interface to update the identified grade to a “0” (step 713). Acceptability of such action substitutions may be specified by the grade provider or grade owner.

The system (101) then connects to the target gradebook through the target specific method (step 714) and transfers the formatted request to the target gradebook (step 715). The system (101) then receives relevant identifiers, status, and errors from the gradebook through the gradebook specific interface (step 716). The system (101) then manipulates the gradebook response into the format necessary for the Common Interface (step 717) and transmits said information to the grade provider (step 718). Step 718 may be completed synchronously, or asynchronously in response to a separate status query by the grade provider to the system (101). Additionally, the status query does not have to be initiated but may be logged, sent to a remote API or web hook, or otherwise maintained for future use.

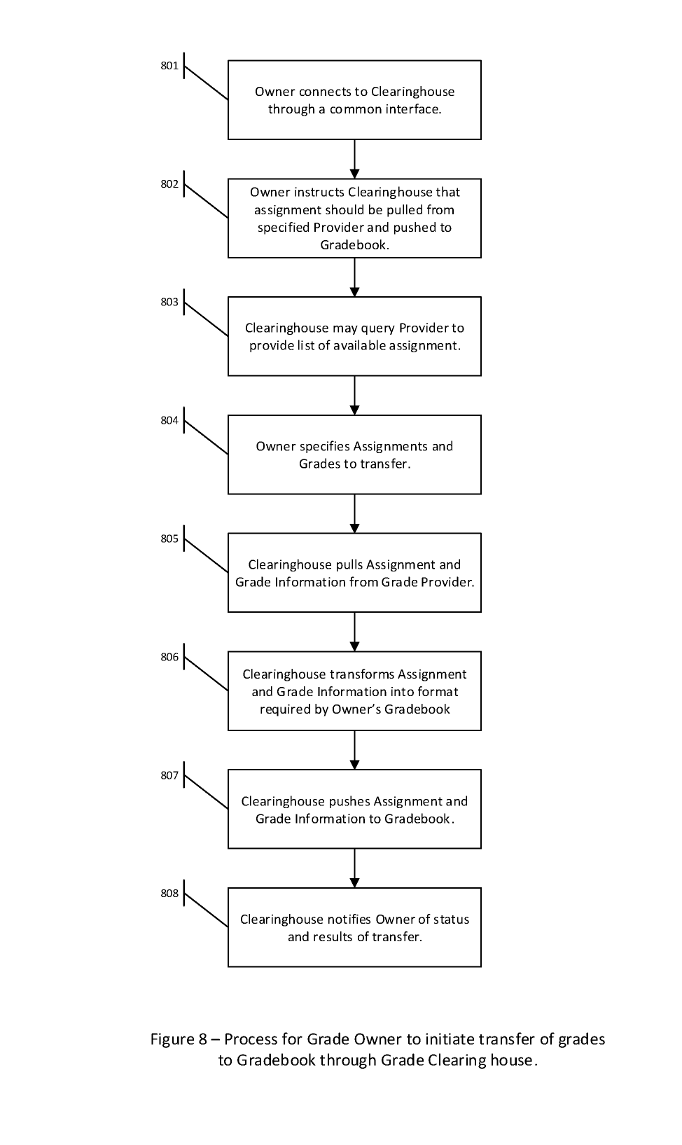

Turning to FIG. 8, one of the plurality of grade owners (105) connects to the system (101) through a common interface through a common interface (step 801), meaning that it does not need to know the type of the one or more of the plurality of grade providers (102), grade users (103), and/or gradebooks (103) it is connecting to, nor the type of interface the target provider, grade user, or gradebook requires. The owner then specifies that information should be transferred from a given grade provider to a given gradebook (step 802). The system (101) may query the specified grade provider for a list of available assignments (step 803). The grade owner may specify a grade, assignment, or group of grades or assignments that should be transferred (step 804). A group may be a specific age or skill group of students, date range, grade range, an intersection or union thereof, or any other grouping based on available information. The system (101) pulls the specified information from the specified grade provider (step 805). The system (101) may use a target specific interface or a custom interface as implemented by the target provider. The system (101) then manipulates the received information into the required format to be transmitted to the target gradebook (step 806). The system (101) pushes the specified information to the specified gradebook (step 807). The system (101) may use a target specific interface or a custom interface as implemented by the target provider. The system (101) notifies the grade owner of the status of the information transfer through the common interface (step 808).

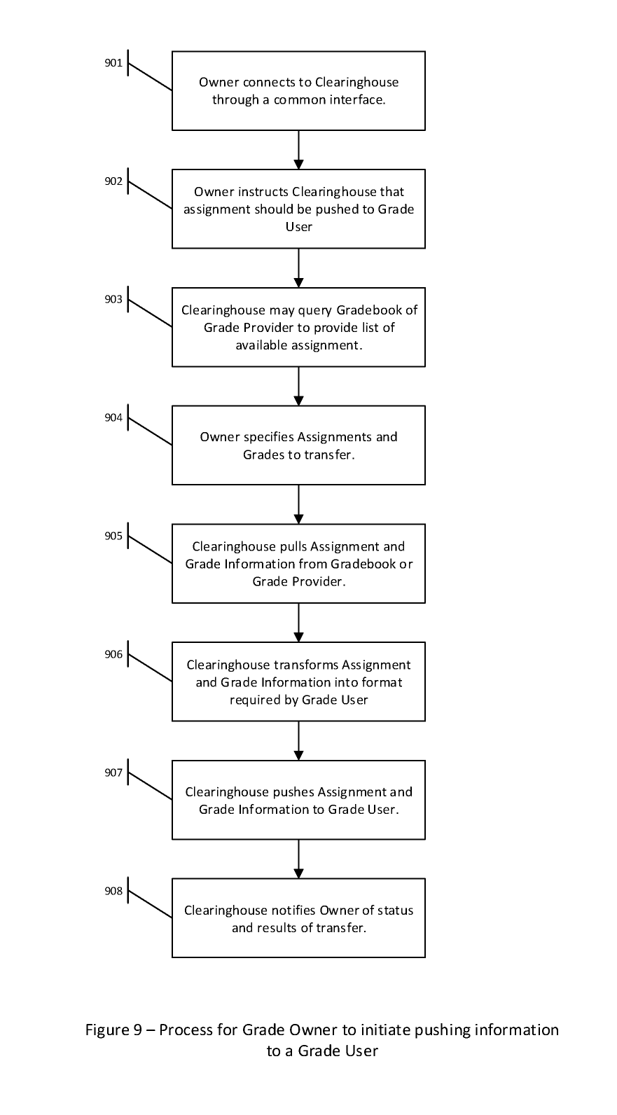

Turning to FIG. 9, one of the plurality of grade owners (105) connects to the system (101) through a common interface (step 901), meaning that it does not need to know the type of the one or more of the plurality of grade providers (102), grade users (103), and/or gradebooks (103) it is connecting to, nor the type of interface the target provider, grade user, or gradebook requires. The owner then specifies that information should be transferred to a given grade user (step 902). The system (101) may query the available gradebooks and/or grade providers for a list of available assignments (step 903). The grade owner may specify a grade, assignment, or group of grades or assignments that should be transferred (step 904). A group may be a specific age or skill group of students, date range, grade range, an intersection of union thereof, or any other grouping based on available information. The group specification may be for a single data transfer or an ongoing, periodic transfer. The system (101) pulls the specified information from the specified grade provider or gradebook (step 905). The system (101) may use a target specific interface or a custom interface as implemented by the target provider. The system (101) then manipulates the received information into the required format to be transmitted to the target gradebook (step 906). The system (101) pushes the specified information to the specified grade user (step 907). The system (101) may use a target specific interface or a custom interface as implemented by the target provider. The system (101) notifies the grade owner of the status of the information transfer through the common interface (step 908). Step 908 may be completed synchronously, or asynchronously in response to a separate status query by the grade provider to the system (101). Additionally, the status query does not have to be initiated but may be logged, sent to a remote API or web hook, or otherwise maintained for future use.

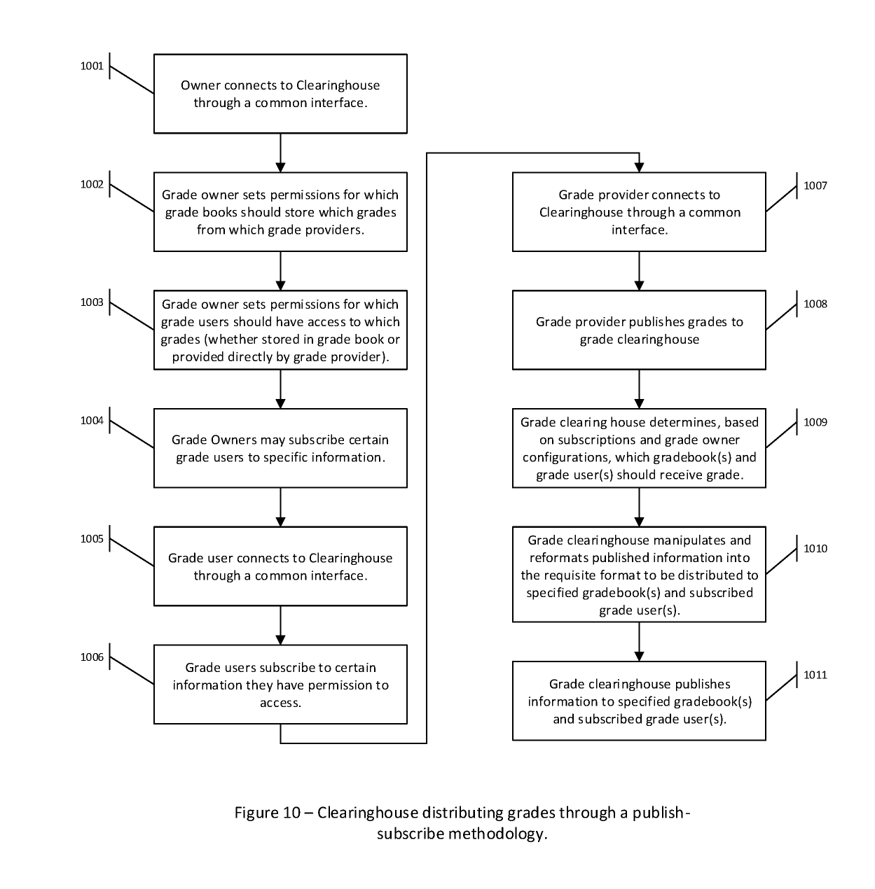

Turning to FIG. 10, one of the plurality of grade owners (105) connects to the system (101) through a common interface (step 1001), meaning that it does not need to know the type of the one or more of the plurality of grade providers (102), grade users (103), and/or gradebooks (104) it is connecting to, nor the type of interface the target provider, grade user, or gradebook requires. The owner sets permissions for which gradebooks should store which grades from which grade providers (step 1002). The owner sets permissions for what information each grade user should have access to (step 1003). Permissions may have any level of granularity. In addition to allowing access, grade owners may subscribe specific users and gradebooks to specific information (step 1004). Steps 1001, 1002, 1003, and 1004 are typically performed as an initial configuration by the grade owners (105), which may be updated from time to time, but are not necessary to be done every time a grade is transferred.

One of the plurality of grade users (103) connects to the system (101) through a common interface (step 1005), meaning that it does not need to know the type of the one or more of the plurality of grade providers (102), grade owners (105), and/or gradebooks (104) it is connecting to, nor the type of interface the target provider, grade user, or gradebook requires. Grade users subscribe to specific information that the system (101) verifies the user has permission to access based upon permissions set by owner (step 1006), Steps 1005 and 1006 are typically performed as an initial configuration by the grade users (103), which may be updated from time to time, but are not necessary to be done every time a grade is transferred. Steps 1005 and 1006 are shown being performed after the permissions have been specified in steps 1001, 1002, 1003, and 1004. However, steps 1005 and 1006 may be performed prior to steps 1001, 1002, 1003, and 1004 to request access to the specified grades, in which case the grade owner (105) may have to approve access before grades are distributed to the subscribing grade users (103).

One of the plurality of grade providers (102) connects to the system (101) through a common interface (step 1005), meaning that it does not need to know the type of the one or more of the plurality of grade users (103), grade owners (105), and/or gradebooks (104) it is connecting to, nor the type of interface the target provider, grade user, or gradebook requires. Grade providers then publish information to the system (101) (step 1008). The system determines gradebooks and grade users that are subscribed to published information (step 1009). System (101) reformats published information into the required format to push it to each of the subscribed gradebooks and grade users (step 1010). System (101) publishes provided information to each of the subscribed gradebooks and grade users (step 1011).

Accordingly, the system allows school grade reports to be completed more easily, efficiently, accurately, fully and quickly. Education tool providers are able to interface to multiple gradebooks through a single interface improving time to market, product offering, and value to customers and users. This allows grade providers to more easily offer a service to automatically populate gradebooks or other grade repositories without having to create and maintain multiple separate interfaces for each one. This removes the burden for a tool provider to implement and maintain separate programmatic interfaces for each gradebook it wishes to automatically push grades to. Instead it may implement and maintain a single interface to the system thereby saving significant time and effort. The system also allows schools or gradebooks to automatically pull grades into their gradebooks from systems and applications that do not provide a service to push them into the gradebook. The system also allows schools or grade displayers to create more complete reports both because the grade book is more complete and because the system is able to provide additional information, such as Standard references and cross Standard correlation, which some gradebooks may not provide. The system also allows a simplified interoperability among the various tools and vendors involved in the assignment and grading processes.

The invention is a system and method that may be implemented in software. This implementation could take multiple forms including Software as a Service (SaaS), a library that is compiled into the tool, or a computer run by the school, gradebook, or tool provider. An individual tool may act as one or more of gradebook, grade provider, and grade user. As such, the system allows a user or school to input data into the system using any form of entry method including Android phone, Apple iPhone, iPad, desktop computer, laptop computer and the like. The Clearinghouse maintained data is stored on the system in the Clearinghouse that may be stored in or run on one or more servers. As such, data is transmitted from user/school to the central servers. The servers may also house the software that converts user data from the individualized systems into a common format. Alternatively, the software may be stored remote from the data.

While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the present invention.

1. A computing apparatus having at least one microprocessor and memory storing instructions configured to instruct the at least one microprocessor to perform operations, the computing apparatus comprising:
a. a system configured to receive input from a plurality of users using a plurality of different interface formats;
b. wherein transferred data includes grades;
c. wherein a data transfer may be initiated through a provided interface without knowledge of the required format of other users;
d. wherein said system is configured to convert said information provided in one format into the format required by a user; and
e. wherein said system is configured to allow for a plurality users to push and/or pull data from said system.

2. The computing apparatus according to claim 1, wherein transferred data also includes assignments.

3. A method of managing grade or assignment information transfer between a plurality of users comprising:
a. receiving said information from said users;
b. converting format of said information into format required by other users;
c. providing said information to said other users.

4. The method according to claim 3, wherein said users push said information to said system.

5. The method according to claim 4, wherein said users push said information to said system using a common set of interfaces.

6. The method according to claim 5, wherein said interfaces are selected from the group consisting of API or file transfer.

7. The method according to claim 4, wherein said system pushes said information to said other users using a plurality of interfaces.

8. The method according to claim 7, wherein said interfaces are selected from the group consisting of API, form filling, file transfer, or manual entry.

9. The method according to claim 3, wherein said other users pull said information from said system.

10. The method according to claim 9, wherein said other users pull said information using a common set of interfaces.

11. The method according to claim 10, wherein said interfaces are selected from the group consisting of API or file transfer.

12. The method according to claim 9, wherein said system pulls said information from said users using a plurality of interfaces.

13. The method according to claim 12, wherein said plurality of interfaces are selected from the group consisting of API, file transfer, screen scraping or direct database query.

14. The method according to claim 3, wherein said system pulls said information from said users.

15. The method according to claim 14, wherein said system pulls said information using a plurality of interfaces.

16. The method according to claim 15, wherein said interface is selected from the group consisting of API, file transfer, screen scraping or direct database query.

17. The method according to claim 14, wherein said system pushes said information to said other users.

18. The method according to claim 17, wherein said system pushes said information to said other users using a plurality of interfaces.

19. The method according to claim 18, wherein said plurality of interfaces are selected from the group consisting of API, form filling, file transfer, or manual entry.

20. The method according to claim 3, wherein said system stores portions of said information.

21. The method according to claim 20, wherein said portions include standard reference information.

22. The method according to claim 3, wherein says system further analyses said information.

23. The method according to claim 14, wherein said analysis is selected from the group consisting of cross correlation of standards jurisdictions, standards coverage analysis and standards satisfaction analysis.

24. The method according to claim 3, wherein system utilizes a publish-subscribe methodology for receiving and providing said information.

25. The method according to claim 3, wherein the grade owner may specify permissions or controls specifying which grade users and gradebooks may receive what information from which other gradebooks and grade providers.

26. The method according to claim 3, wherein the grade owner may cause information to be pulled from one user and provided to another user.

27. The method according to claim 3, wherein the user initiating an action is not required to be aware of the information format required by other users involved in the action.
